(19) United States
(12) Patent Application Publication
(10) Pub. No.: US 2014/0210223 A1
(43) Pub. Date: Jul. 31, 2014

(54) SPREADER BAR WITH INTEGRAL SCALE

(71) Applicant: Julie Lamela, Huntley, IL (US)

(72) Inventor: Julie Lamela, Huntley, IL (US)

(21) Appl. No.: 13/750,634

(22) Filed: Jan. 25, 2013

(51) Int. Cl. B66C 1/22; A61G 7/10

(52) U.S. Cl. CPC B66C 1/22; A61G 7/108
USPC 294/81.5

(57) ABSTRACT

A spreader bar for use with a boom lift or ceiling is disclosed. The spreader bar includes at least two arms and an integral scale. Ideally, the load sensor of the scale is located within the spreader bar, preferably centrally within a cavity located between the arms. Thus, there is zero lift height loss when using the spreader bar since a separate scale need not be added between the spreader bar and the boom. Preferably, a pivoting connection member is provided to mount the spreader bar to the boom. The pivoting connection member allows tilting of the spreader bar in any direction perpendicular to the vertical axis. Ideally, 360 degrees of rotation is also provided by the connection member.

### BACKGROUND OF THE INVENTION

1. Field of the Invention

The present invention relates to a spreader bar for use with a boom lift or ceiling lift, and more particularly, to a spreader bar having an integral scale.

2. Background

Conventional spreader bars are frequently used to attach to boom lifts or ceiling lifts. The spreader bars have connection elements to connect a sling. Such lifts are often used in the healthcare, hospice, and other industries in order to help move individuals having mobility limitations. Other uses include industrial uses in which various objects are required to be moved. Because of the various uses for these lifts, the height to which the individual can be raised must be at least a certain minimum height to insure that various obstacles are cleared.

In many situations, it is convenient or necessary to weigh a patient or a load on the boom lift or ceiling lift when the patient or object is lifted. Many conventional boom lifts have no built-in scale capable of measuring the weight of the load. Thus, it is often the case that an add-on scale is added. Such a scale is typically placed between the spreader bar and the connection point to the boom. While this can achieve the goal of measuring the weight of the load, there are disadvantages of this arrangement. For example, it creates what is known as “loss of lift height,” i.e., it adds distance between the spreader bar and the boom which means the height to which a load can be raised is reduced. This can be a significant problem when lift height is crucial.

Various apparatus have been previously proposed for addressing various issues associated with spreader bars, boom lifts, and weight measurement. For example, U.S. Pat. No. 7,657,951, issued to Tally, exemplifies a typical conventional boom lift device. No weight measurement system is integrated. Thus, an additional scale would need to be added to the system, which would conventionally reduce the lift height. Furthermore, damage can occur to the system when a patient load is tilted since a mechanism which can withstand the forces created with tilting and rotating is not incorporated.

U.S. Pat. No. 4,482,783, issued to Laimins, discloses a patient lifting device having a scale. At least two load sensors are required due to the torsion placed on the devices with various loads, and tilting and rotating is not addressed.

Numerous other devices have been proposed, but the situation remains that in order to add a scale to a conventional boom lift and spreader bar apparatus, too great an amount of lift height is lost. Furthermore, in numerous situations, apparatus are damaged because the load is pushed or moved via momentum to produce a tilting force between the spreader bar and the boom. Conventional lifts are prone to failure in this mode.

Thus, there continues to be a need for a spreader bar for use with a boom lift which enables the integration of a scale without losing too great an amount of lift height, or ideally, with zero loss of lift height. Furthermore, there continues to be a need for a spreader bar which can allow and withstand tilting in various directions without being prone to failure in a tilting mode.

### SUMMARY

The present invention is a spreader bar with an integral scale. In various embodiments, the spreader bar includes at least two arms. Preferably, a single load sensor is integrated within the spreader bar.

In various embodiments, the spreader bar preferably includes an interior cavity located between the two arms. The load sensor is preferably disposed within the interior cavity. In this fashion, the spreader bar with integral scale allows the system to be used without greatly increasing the distance between the connection pin of the boom and the connection points at the distal ends of the arms of the spreader bar. Thus, the height loss associated with having a spreader bar and scale is minimized or eliminated altogether.

In some embodiments, the spreader bar includes a pivoting connection member such as a pin which is mounted to the top of the spreader bar. The pin enables the spreader bar to tilt with respect to the vertical axis of the connection member. Ideally, the pin enables the spreader bar to tilt in any direction perpendicular to the vertical axis of the spreader bar. This enables a loaded spreader bar to tilt in the event the load is pushed directly, or in the event momentum causes the loaded spreader bar to tilt. The tilt allowed is ideally at least 10 degrees from the vertical axis, and preferably up to 15 degrees from the vertical axis or more, although any amount of tilt allowance is contemplated to be within the scope of the present invention.

As load sensors can be sensitive to torsion and twisting, in certain embodiments, the pivoting connection member, in allowing the spreader bar to tilt, acts to balance the forces on the load sensor in a way which allows the load sensor to function properly even when the spreader bar is tilted. Because of the central location of the load sensor and the pivoting connection member, a single load sensor can be used without the need for any additional load sensor.

In certain embodiments, the pivoting connection member additionally allows rotation, preferably 360 degree rotation, or continuous unlimited rotation, in the plane which is perpendicular to the vertical axis of the connection member. Thus, full rotation and tilting in any direction is enabled by the connection member which helps to avoid failure in any of those modes.

Preferably, the pivoting connection member, or at least certain interfacing portions thereof, is composed of a silicone impregnated bronze such as that known currently as C655 Bronze. Thus, no lubrication or maintenance of these parts is required over time. It is emphasized, however, that any suitable material may be used for the various parts of the connection member.

In some embodiments, a scale display is disposed on the spreader bar. The scale display is operably connected to the load sensor, and displays a weight associated with the load. The display may be an LED display, or any other suitable form of display. Ideally, it is located centrally, between the arms and outside of the interior cavity. However, any suitable location for the display is contemplated, whether on or as a part of the spreader bar itself, adjacent the interior cavity, or elsewhere.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 shows a perspective view of a prior art boom lift with a conventional spreader bar.

FIG. 2 shows a perspective view of a prior art boom lift with a conventional spreader bar and an added scale.

FIG. 3 shows a perspective view of one embodiment of the spreader bar with integral scale of the present invention.

FIG. 4 shows a perspective view of one embodiment of the spreader bar with integral scale of the present invention attached to a boom lift apparatus.

FIG. 5 shows a perspective view of one embodiment of the spreader bar interior cavity of the present invention showing a load sensor with a central cavity and a pivoting connection member.

FIG. 6 shows a perspective view of one embodiment of the pivoting connection member of the present invention.

FIG. 7 shows a sectional view of one embodiment of the pivoting connection member of the present invention.

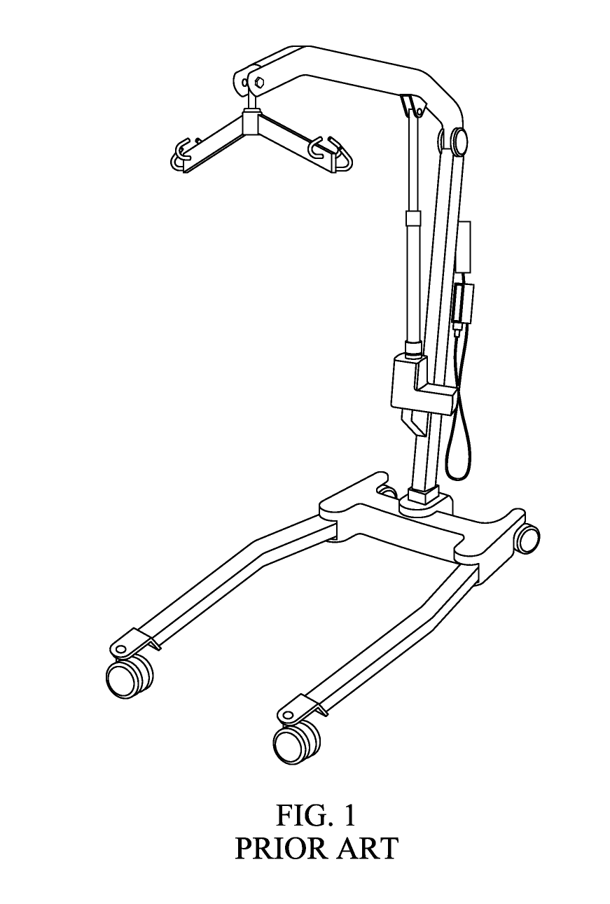

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention is a spreader bar 10 for use with a boom lift 20, a ceiling lift, or any other type of lift with which a spreader bar may be used. The spreader bar 10 includes at least two arms including a first arm 30 and a second arm 40. In various embodiments, a scale is integral with the spreader bar 10. The scale includes a load sensor 50, which could be a load cell or any suitable component capable of sensing a load. Preferably, the load sensor 50 is disposed centrally so that no additional load sensor is required. In certain embodiments, the load sensor 50 is disposed at least partially within the spreader bar 10. The load sensor 50 is positioned and adapted to sense a load acting on the spreader bar 10, such as when a patient or other load is placed on a sling attached to the spreader bar 10 while the spreader bar is suspended from a lift such as a boom lift 20 or ceiling lift.

In certain embodiments, an electronic scale display 60 is operatively connected to the load sensor 50 and disposed on the spreader bar 10 so that the display 60 is readable on the spreader bar 10. Thus, the display 60, ideally an LED display, but it may be any suitable display 60, may be configured to show a weight associated with the load sensed.

In various embodiments, the first arm 30 includes a proximal end 35, and the second arm 40 includes a proximal end 45. Ideally, the load sensor 50 is disposed between the proximal ends 35 and 45. In some embodiments, the spreader bar 10 includes structure which houses an interior cavity 70 centrally located between the proximal ends 35 and 45 of the arms 30 and 40. The load sensor 50 is ideally disposed within this interior cavity 70, and attached at one end at the bottom of the cavity 70. The top end of the load sensor 70 is attached to a connection member 80.

In various embodiments, ideally, there is only a single load sensor 50 which is centrally located within the spreader bar 10, without the need for any additional load sensors.

In certain embodiments, the spreader bar 10 is attached to a pivoting connection member 80. Ideally, the pivoting connection member 80 attaches to the top of the load sensor 50. The connection member 80 is adapted to connect to a connection point above the spreader bar 10. Preferably, it is adapted to allow tilting of the spreader bar 10 with respect to a vertical axis of the pivoting connection member 80 in any direction perpendicular to the vertical axis. This allows the spreader bar 10 to be tilted to any desired degree. For example, it may be capable of allowing a tilt in any direction within that plane of up to 10 degrees, or even up to 15 degrees or greater. This allows the boom lift 20 or ceiling lift to be used under certain circumstances which cause this type of tilting without failing due to the forces incurred.

In various other embodiments, the pivoting connection member 80 is adapted to balance forces on the load sensor 50 due to its tilting configuration when the spreader bar 10 is in a tilted position. Thus, the pivoting connection member 80 enables the load sensor 50 to accurately measure the magnitude of a load when the spreader bar 10 is in such a tilted position.

In addition to tilting, the connection member 80 preferably allows the spreader bar 10 to rotate about the vertical axis within the plane perpendicular to the vertical axis. Ideally, 360 degrees of rotation, or continuous unlimited rotation, is enabled by the connection member 80.

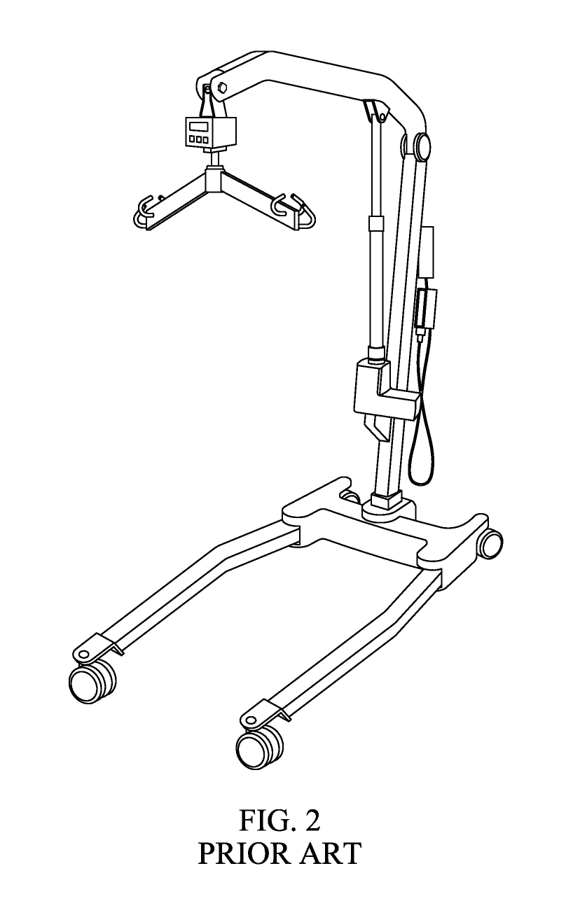

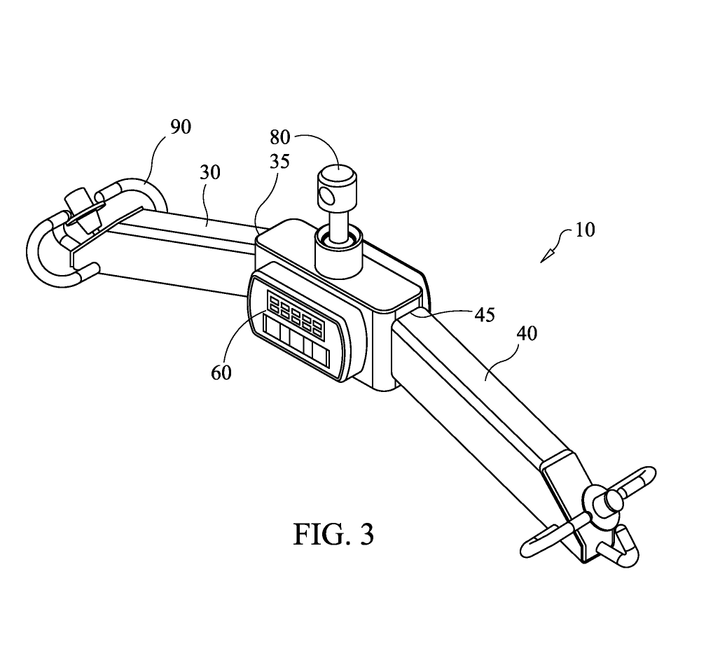

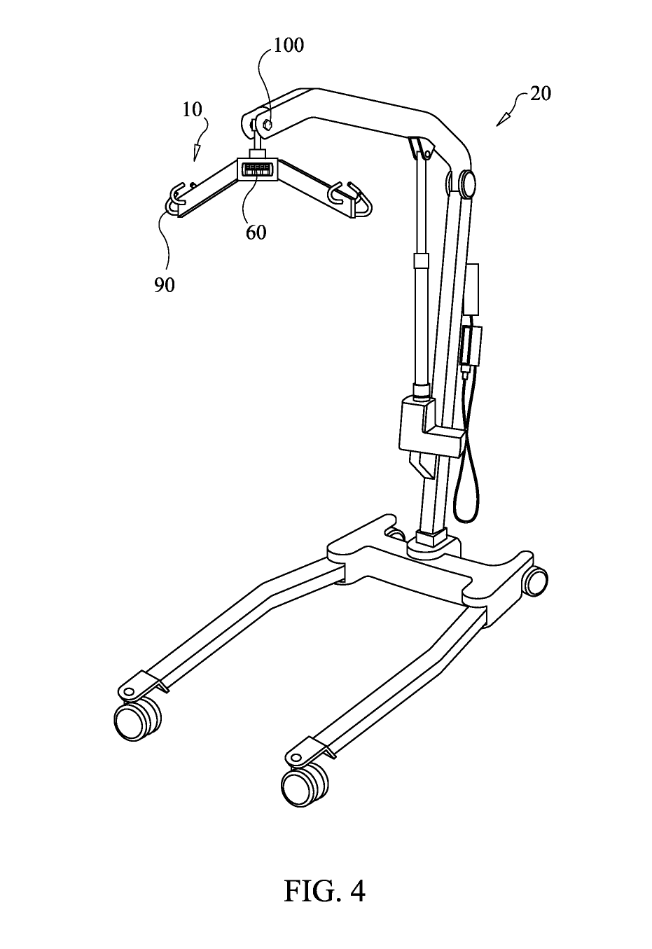

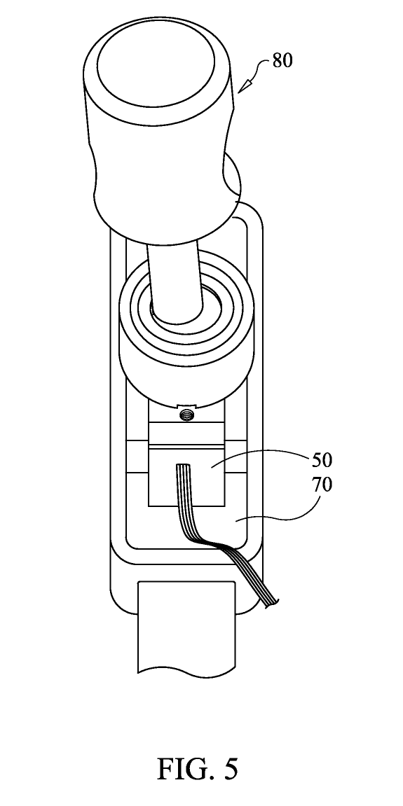

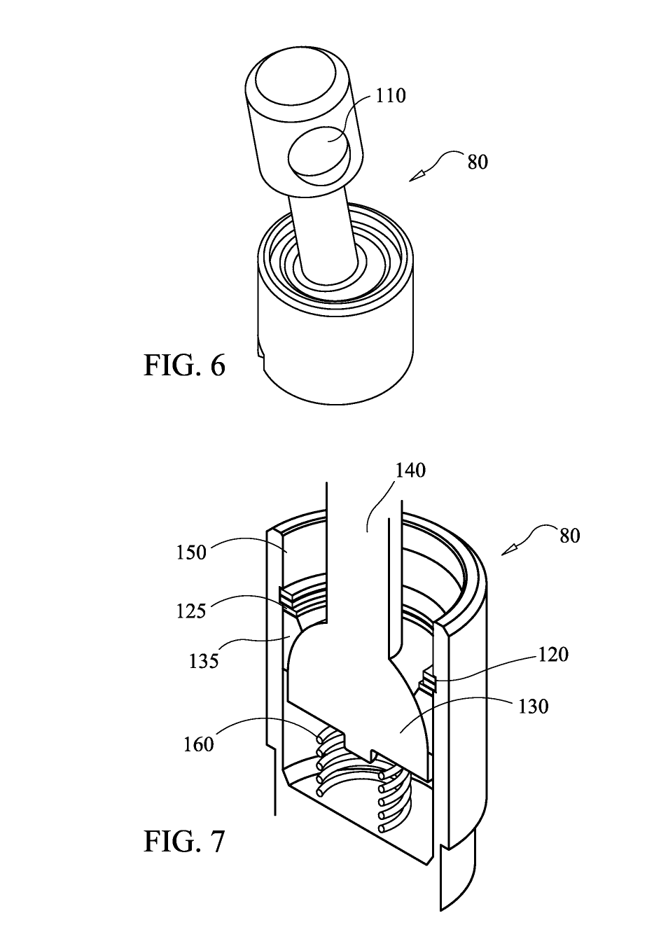

In various embodiments, the spreader bar 10 allows for a scale to be integrated into the system without losing a substantial amount, or any, lift height. This can be measured using a spreader bar distance defined by the vertical distance between the spreader bar distal end lowest sling connection point which is the lowest point to which a sling may be connected to connector 90, and a center axis of a connection member 100 when the spreader bar is connected to a lift. In order to compare this distance to that in a conventional system, a “conventional type spreader bar” is defined as a conventional spreader bar which has a sling connector 90 which is vertically lower than a lift connection member 100 when connected to a lift. A conventional type spreader bar distance may then be defined as the vertical distance between the conventional type spreader bar lowest sling connection point and the center axis of the connection member 100 when connected to a lift, whether with or without a separate scale component placed therebetween. In some embodiments, the spreader bar distance when the spreader bar 10 is connected to a lift, is less than the conventional type spreader bar distance when such a conventional type spreader bar is connected to a scale placed between such a conventional spreader bar and a lift, such as the configuration as shown in Prior Art FIG. 2.

In other embodiments, this same distance is not more than one inch greater than the convention spreader bar distance when a separate scale component is not included between the conventional type spreader bar and the lift connection member 100. Thus, either only a small amount of lift height is lost, or in certain embodiments, no loss in lift height is created.

Regardless of whether a scale is incorporated into the spreader bar 10, in certain embodiments, a pivoting connection member 80 allows for the advantages and features discussed above. The pivoting connection member 80 preferably includes a hole 110 through which a connector such as a connecting bolt 100 may pass. Any suitable connecting element 100 may be used, however, in various preferred embodiments, a bolt 100 is used. The pivoting connection member 80 is composed of various elements. Some of these elements interface with one another. In certain preferred embodiments, various interfacing embodiments are composed of a self-lubricating material. Any suitable self-lubricating material is contemplated. Various materials may include a silicone impregnated bronze such as C655 Bronze. This allows the pivoting connection member 80 to operate without the need for lubrication, and without the need for maintenance. This is important as certain environments in the healthcare industry require that no lubrication of parts be used.

While numerous configurations are possible for the pivoting connection member 80, ideally the pivoting connection member 80 is configured to tilt in any direction and to rotate freely. In certain embodiments, a retaining clip or ring 120 is provided to hold parts into an outer structure 150. A washer 125 may be positioned between the retaining clip or ring 120, which may hold an interfacing element 135. The interfacing element 135 is ideally formed of a self-lubricating material, as discussed above, such as C655 Bronze. The interfacing element 135 interfaces with a dome element 130, which may be held up by a spring 160 such as a crest spring positioned below the dome element 130. Attached to the dome element 130 is a central post 140 which, together with the dome element 130, is able to tilt and rotate with respect to the outer structure 150.

While specific embodiments have been illustrated and described, numerous modifications come to mind without significantly departing from the spirit of the invention and the scope of protection is limited by the scope of the accompanying claims.

What is claimed is:

1. A spreader bar for use with a boom lift or ceiling lift comprising:
at least a first arm and a second arm, and
a load sensor disposed at least partially within said spreader bar, wherein said load sensor is adapted to sense a load acting on said spreader bar when said spreader bar is suspended from a boom lift or ceiling lift.

2. The spreader bar according to claim 1, further comprising:
an electronic scale display operatively connected to said load sensor and disposed on said spreader bar.

3. The spreader bar according to claim 1, wherein said load sensor is centrally disposed within said spreader bar.

4. The spreader bar according to claim 3, wherein said load sensor is disposed within an interior cavity centrally located within said spreader bar.

5. The spreader bar according to claim 1, wherein said first arm includes a proximal end, wherein said second arm includes a proximal end, and wherein said load sensor is disposed between the proximal end of said first arm and the proximal end of said second arm.

6. The spreader bar according to claim 3, wherein said load sensor is a sole load sensor within said spreader bar, said spreader bar comprising no additional load sensor.

7. The spreader bar according to claim 1, further comprising a pivoting connection member adapted to connect to a connection point above said spreader bar, and adapted to allow tilting of said spreader bar with respect to a vertical axis of said pivoting connection member in any direction perpendicular to the vertical axis.

8. The spreader bar according to claim 7, wherein said pivoting connection member is adapted to balance forces on said load sensor when said spreader bar is in a tilted position, wherein said pivoting connection member is adapted to enable said load sensor to accurately measure the magnitude of a load when said spreader bar is in such a tilted position.

9. The spreader bar according to claim 8, wherein said pivoting connection member is adapted to allow 360 degrees of rotation of said spreader bar with respect to said pivoting connection member within a plane perpendicular to the vertical axis.

10. The spreader bar according to claim 1, wherein said spreader bar has a spreader bar distance defined by a vertical distance between a spreader bar distal end lowest sling connection point and a connection point defined by a center axis of a lift connection member connecting said spreader bar to a lift when said spreader bar is connected to such a lift, and
wherein a conventional type spreader bar distance is defined by a vertical distance between a conventional type spreader bar distal end lowest sling connection point and a connection point defined by a center axis of a connection member connecting a separate scale component to such a lift when said conventional type spreader bar is connected to such a separate scale component disposed between such a conventional type spreader bar and such a lift, and
wherein said spreader bar distance is less than said conventional type spreader bar distance.

11. The spreader bar according to claim 1, wherein said spreader bar has a spreader bar distance defined by a vertical distance between a spreader bar distal end lowest sling connection point and a connection point defined by a center axis of a lift connection member connecting said spreader bar to a lift when said spreader bar is connected to such a lift, and
wherein a conventional type spreader bar distance is defined by a vertical distance between a conventional type spreader bar distal end lowest sling connection point and a connection point defined by a center axis of a lift connection member connecting such a conventional type spreader bar to a lift when said conventional type spreader bar is connected to such a lift, and
wherein said spreader bar distance is not more than one inch greater than said conventional type spreader bar distance.

12. The spreader bar according to claim 1, wherein said spreader bar has a spreader bar distance defined by a vertical distance between a spreader bar distal end lowest sling connection point and a connection point defined by a center axis of a lift connection member connecting said spreader bar to a lift when said spreader bar is connected to such a lift, and
wherein a conventional type spreader bar distance is defined by a vertical distance between a conventional type spreader bar distal end lowest sling connection point and a connection point defined by a center axis of a lift connection member connecting such a conventional type spreader bar to a lift when said conventional type spreader bar is connected to such a lift, and
wherein said spreader bar distance is not greater than said conventional type spreader bar distance.

13. A spreader bar for use with a boom lift or ceiling lift comprising:
a spreader bar structure,
a pivoting connection member mounted to said spreader bar structure, adapted to connect to a connection point above said spreader bar structure, and adapted to allow tilting of said spreader bar with respect to a vertical axis of said pivoting connection member in any direction perpendicular to the vertical axis.

14. The spreader bar according to claim 13, wherein said pivoting connection member is adapted to allow 360 degrees of rotation of said spreader bar with respect to said pivoting connection member within a plane perpendicular to the vertical axis.

15. The spreader bar according to claim 13, wherein said pivoting connection member is adapted to allow tilting of said spreader bar up to at least 10 degrees with respect to the vertical axis of said pivoting connection member in any direction perpendicular to the vertical axis.

16. The spreader bar according to claim 14, wherein said pivoting connection member is adapted to allow tilting of said spreader bar up to at least 10 degrees with respect to the vertical axis of said pivoting connection member in any direction perpendicular to the vertical axis.

17. The spreader bar according to claim 13, wherein said pivoting connection member comprises at least one interfacing part comprising a self-lubricating material.

18. The spreader bar according to claim 17, wherein said pivoting connection member requires no lubrication maintenance in order to keep functioning over time.

19. A spreader bar system for use with a boom lift or ceiling lift comprising:
a spreader bar having at least a first arm and a second arm, and
a load sensor positioned and adapted to sense a load applied to said spreader bar,
wherein said spreader bar has a spreader bar distance defined by a vertical distance between a spreader bar distal end lowest sling connection point and a connection point defined by a center axis of a lift connection member connecting said spreader bar to a lift when said spreader bar is connected to such a lift, and
wherein a conventional type spreader bar distance is defined by a vertical distance between a conventional type spreader bar distal end lowest sling connection point and a connection point defined by a center axis of a lift connection member connecting such a conventional type spreader bar to a lift when said conventional type spreader bar is connected to such a lift, and
wherein said spreader bar distance is not more than one inch greater than said conventional type spreader bar distance.

20. A spreader bar system for use with a boom lift or ceiling lift comprising:
a spreader bar having at least a first arm and a second arm, and
a load sensor positioned and adapted to sense a load applied to said spreader bar,
wherein said spreader bar has a spreader bar distance defined by a vertical distance between a spreader bar distal end lowest sling connection point and a connection point defined by a center axis of a lift connection member connecting said spreader bar to a lift when said spreader bar is connected to such a lift, and
wherein a conventional type spreader bar distance is defined by a vertical distance between a conventional type spreader bar distal end lowest sling connection point and a connection point defined by a center axis of a lift connection member connecting such a conventional type spreader bar to a lift when said conventional type spreader bar is connected to such a lift, and
wherein said spreader bar distance is not greater than said conventional type spreader bar distance.
